(19) United States
(12) Patent Application Publication
(10) Pub. No.: US 2005/0075824 A1
(43) Pub. Date: Apr. 7, 2005

(54) Auto-test system for testing the stability of a computer device

(75) Inventor: Tzer-Min Lee, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/762,255

(22) Filed: Jan. 23, 2004

(30) Foreign Application Priority Data
Sep. 19, 2003 (TW) 092216876

(51) Int. Cl. G06F 19/00

(52) U.S. Cl. 702/130

(57) ABSTRACT

An auto-test system for testing the stability of a computer is disclosed. First, a tested computer is placed in a testing chamber. Afterwards, the temperature in the testing chamber and the operating voltage of the computer under test are set automatically, and the test results are also recorded automatically by the auto-test system of the present invention. Consequently, the stability test of the computer under test can be carried out automatically, and the manpower needed for setting the operating temperatures and operating voltages can be saved.

### BACKGROUND OF THE INVENTION

1. Field of the Invention

The present invention relates to an auto-test system and, more particularly, to an auto-test system suitable for testing the stability of a computer device.

2. Description of Related Art

Typically, a computer manufacturing company or computer repairing station will provide a testing chamber to test the stability or performance of a tested object, e.g. a personal computer. By setting a critical operating voltage and a critical operating temperature, the computer will be operated at a severe condition, and the stability or performance of the computer is therefore obtained. For example, the operating voltage may be set at 10% less than the standard operating voltage, and the operating temperature at 40 degrees C. In addition, a high loading software program, such as Windows™ may be executed in the computers, or hardware tests may be repeatedly carried out during the test procedure. For example, the computer under test is reset repeatedly and the operation situation of the computer is observed carefully. If the computer operates normally, a new operating voltage and a new operating temperature are applied to carry out the above-mentioned test again. If the computer operates abnormally, the operating voltage and temperature are recorded, and then a new operating voltage and a new operating temperature are applied to carry out the above-mentioned test again. If 10 minutes is required to carry out each test, sixteen operating voltages are to be tested, and six operating temperatures are to be tested, sixteen hours, i.e. about two working days, is needed to carry out the whole set of tests manually. Therefore, it is obvious that the stability and performance test of a computer will consume a lot of manpower and time, and is therefore inefficient.

### SUMMARY OF THE INVENTION

The object of the present invention is to provide an auto-test system so that the stability of computers is tested automatically.

Another object of the present invention is to provide an auto-test system that can be operated without operators so that the manpower previously required is eliminated.

To achieve the object, the auto-test system for testing the stability of a computer of the present invention includes at least one programmable power supply for providing at least one operating voltage for the object under test; a temperature setting device mounted in the testing chamber for controlling the temperature in the testing chamber and thereby setting an operating temperature; and a control computer for setting the programmable power supply and thereby adjusting the operating voltage, and setting the temperature setting device and thereby adjusting the operating temperature; wherein the object under test operates at the operating voltage and the operating temperature, and then outputs a testing result to be recorded by the control computer.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram showing the auto-test system of the present invention; and

FIG. 2 is a flow chart showing the test procedure of the auto-test system of the present invention.

### DETAILED DESCRIPTION OF THE PREFERRED EMBODIMENT

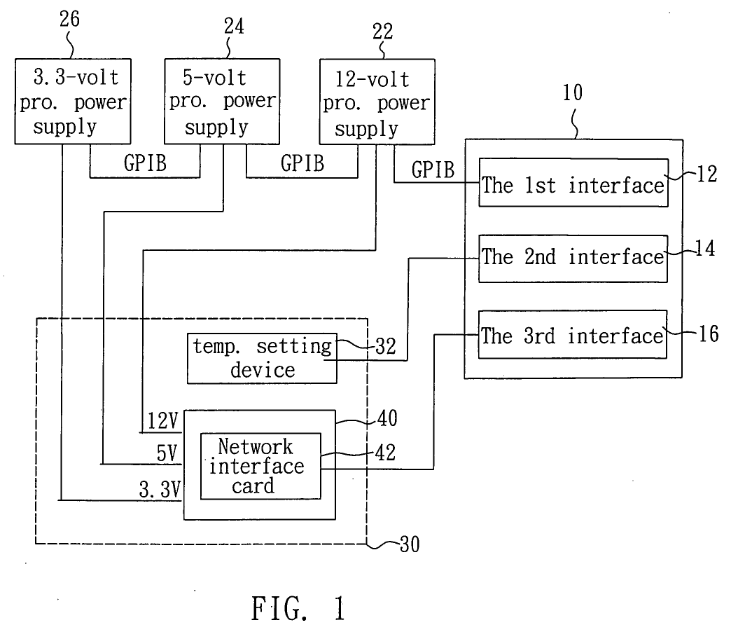

As shown in FIG. 1, the auto-test system of the present invention uses a control computer 10 to control the temperature in the testing chamber 30 (and thereby to provide the tested computer with a desired operating temperature) and to control the output voltage of each power supply (and thereby to provide the tested computer with a desired operating voltage). The computer 40 in the testing chamber 30 accepts the various operating voltages supplied by those power supplies and then executes a software program or a hardware test. Further, the computer 40 is connected to a power source, such as a 110-volt alternating current power, which is not a parameter to be observed and is therefore not controlled (for example, using a standard 110-volt alternating current power). Hence, the control computer 10 sets the operating temperature and each operating voltage automatically, and obtains the testing results without manpower being involved. Therefore, the present invention saves the manpower and has a high efficiency.

The auto-test system of the present invention has a control computer 10, which sets the operating temperature and the operating voltage, and records the test results. The control computer 10 has a first control interface 12, a second control interface 14, and a third control interface 16. The control computer 10 sets all kinds of operating voltage by the first control interface 12, and sets the operating temperature by the second control interface 14. Through the third control interface 16, the control computer 10 can transmit information to the computer 40 or receive information from the computer 40, and thereby ensures the computer 40 operates normally and achieves the test rate of progress. The control computer 10 can be a personal computer, a desktop computer, a portable computer, or a server.

The first control interface 12 can be a General Purpose Interface Bus (GPIB), also known as IEEE 488. The first control interface 12 is used to set the voltage levels of the voltages output by a 12-volt programmable power supply 22, a 5-volt programmable power supply 24, or a 3.3-volt programmable power supply 26, and thereby provides various kinds of operating voltage. For example, the first control interface 12 can make the 12-volt programmable power supply 22 output a first operating voltage of 10.8 volts (10% less than 12 volts), make the 5-volt programmable power supply 24 output a second operating voltage of 5.5 volts (10% more than 5 volts), or make the 3.3-volt programmable power supply 26 output a third operating voltage of 3.135 volts (5% less than 3.3 volts) to the computer 40 in the testing chamber 30. Besides, the first control interface 12 can be a Universal Serial Bus (USB) or a Fire Wire (also known as IEEE 1394). Moreover, the GPIB may transmit information by way of chain connecting. For example, the information in the GPIB is first transmitted to the 12-volt programmable power supply 22 by the GPIB, then transmitted to the 5-volt programmable power supply 24 by the 12-volt programmable power supply 22, and finally transmitted to the 3.3-volt programmable power supply 26 by the 5-volt programmable power supply 24. Also, there are many variations in the voltage levels of the voltages outputted by the 12-volt programmable power supply 22. For example, the output voltage of the 12-volt programmable power supply 22 may have +/−10%, +/−5%, or 0% difference from the standard 12 volts. Therefore, the 12-volt programmable power supply 22 can provide five choices of operating voltage. However, the choice of operating voltage provided by the 12-volt programmable power supply 22 depends on the real requirement and is not restricted to the afore-mentioned situation. The choice of operating voltage provided by the 5-volt programmable power supply 24 or the 3.3-volt programmable power supply 26 is similar to the 12-volt programmable power supply 22, and thus a detailed description is deemed unnecessary.

The second control interface 14 may be an RS-232 interface used for setting the temperature in the testing chamber 30, i.e. the operating temperature when the computer 40 is tested. The operating temperature ranges from −10 to +50 degrees C., between which the operating temperature is set but not restricted to be some specific temperatures, such as −10 degrees C., 0 degrees C., 25 degrees C., 40 degrees C., and 50 degrees C. In addition to the RS-232, the second control interface 14 can be the USB, the IEEE 1394, or the IEEE 488.

The third control interface 16 can be a network interface card, which communicates with the network interface card 42 of the computer 40 in the testing chamber 30 for calculating, for example, the testing loop number that the computer 40 is executing, detecting whether the computer 40 executes the testing software normally, or commanding the computer 40 to reset.

The 12-volt programmable power supply 22 receives the command issued by the first control interface 12, and then provides a first operating voltage of a specific voltage level according to the command.

The 5-volt programmable power supply 24 receives the command issued by the first control interface 12, and then provides a second operating voltage of a specific voltage level according to the command.

The 3.3-volt programmable power supply 26 receives the command issued by the first control interface 12, and then provides a third operating voltage of a specific voltage level according to the command.

The testing chamber 30 is a hermetic room, in which a temperature setting device 32 is mounted. The temperature setting device 32 has an RS-232 interface for receiving the commands issued by the second control interface 14 and controlling the temperature in the testing chamber 30 according to the commands. In addition to the RS-232, other interfaces, such as the USB, the IEEE 1394, or the IEEE 488 can also be used in the temperature setting device 32. Further, the interface used in the temperature setting device 32 is corresponding to the second control interface 14.

In this embodiment, the computer 40 is a tested object, which has a network interface card 42. The computer 40 proceeds with the related procedures, e.g. the execution of testing software, the output of test results, the output of current hardware conditions, or the output of the testing loop number according to the commands issued by the network interface card 42.

The network interface card 42 is a receiving and transmitting interface, which communicates with network interface card 16 so that the computer 40 can receive the commands issued by the control computer 10, thereby executing the corresponding procedures, and transmitting the test results to the control computer 10.

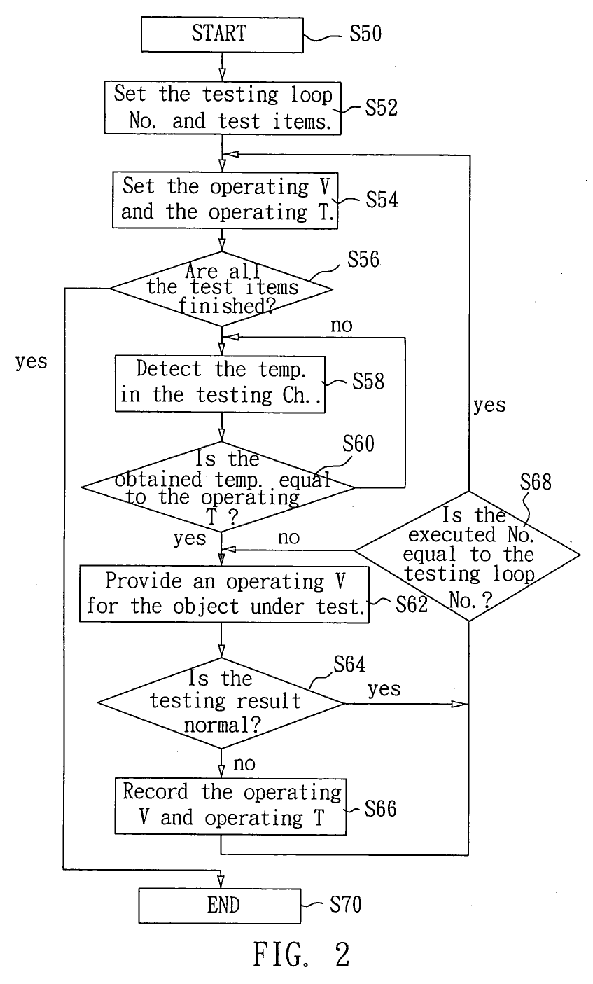

The stability test of the tested object is carried out according to the auto-test procedure of the present invention. As shown in FIG. 2, the auto-test procedure of the present invention includes the following steps:

Step S50: Start.

Step S52: Set the testing loop number and the test items. The test items preferably include various test software and hardware resetting actions. Furthermore, when the execution number is equal to the testing loop number issued by the user, the next test item will be proceeded with.

Step S54: Set the operating voltage and the operating temperature. In order to test the stability of the tested object, a variety of operating voltages and a variety of operating temperatures are designed to test the object under test. By recording the operating condition, the stability of the tested object can be concluded.

Step S56: Determine if all the test items are completed. If all the test items are completed, the process goes to step S70; otherwise, the process goes to step S58.

Step S58: Detect the temperature in the testing chamber. Because the temperature changes slower than the voltage level, the temperature in the testing chamber reaches the operating temperature first. After the temperature in the testing chamber reaches the set operating temperature, the programmable power supply is enabled to provide the preset operating voltage.

Step S60: Determine if this temperature is equal to the test temperature or not. If yes, the process goes to step S62; otherwise the process goes to step S58.

Step S62: Provide the object under test with the preset operating voltage. Under the specific operating temperature, the GPIB makes the programmable power supply provide the object under test with an operating voltage of a specific level to carry out the stability test.

Step S64: Determine whether the test result is normal. If yes, the process goes to step S68; otherwise the process goes to step S66.

Step S66: Record this operating voltage and this operating temperature. The object under test does not pass the test under this operating voltage and this operating temperature, and thus the data are recorded to understand the endurance to the environment and the limit of the object under test, and to re-design or improve the object under test.

Step S68: Determine if the executed number reaches the testing loop number or not. If yes, the process goes to step S54; otherwise the process goes to step S62. Whenever a test is completed, the execution number is incremented until the execution number is equal to the testing loop number. Afterwards, another software or hardware test may be proceeded with.

Step S70: End.

The auto-test system of the present invention sets a variety of operating temperatures and operating voltages automatically to carry out the stability test of the tested object, and the test method thereof has been illustrated in the auto-test procedure aforesaid. Therefore, the objects of the present invention can be achieved successfully.

Although the present invention has been explained in relation to its preferred embodiment, it is to be understood that many other possible modifications and variations can be made without departing from the spirit and scope of the invention as hereinafter claimed.

1. An auto-test system for testing the stability of an object under test in a testing chamber, comprising:
at least one programmable power supply for providing at least one operating voltage for the object under test;
a temperature setting device mounted in the testing chamber for controlling the temperature in the testing chamber and thereby setting an operating temperature; and
a control computer for setting the programmable power supply and thereby adjusting the operating voltage, and setting the temperature setting device and thereby adjusting the operating temperature;
wherein the object under test operates at the operating voltage and the operating temperature, and then outputs a testing result to be recorded by the control computer.

2. The auto-test system as claimed in claim 1, wherein the at least one programmable power supply includes: a 12-volt programmable power supply, a 5-volt programmable power supply, and a 3.3-volt programmable power supply.

3. The auto-test system as claimed in claim 2, wherein the at least one operating voltage provided by the 12-volt programmable power supply is 12 volts, 5% deviation from 12 volts, or 10% deviation from 12 volts.

4. The auto-test system as claimed in claim 2, wherein the at least one operating voltage provided by the 5-volt programmable power supply is 5 volts, 5% deviation from 5 volts, or 10% deviation from 5 volts.

5. The auto-test system as claimed in claim 2, wherein the at least one operating voltage provided by the 3.3-volt programmable power supply is 3.3 volts, 5% deviation from 3.3 volts, or 10% deviation from 3.3 volts.

6. The auto-test system as claimed in claim 1, wherein the operating temperature ranges from −10 degrees C. to 50 degrees C.

7. The auto-test system as claimed in claim 1, wherein the control computer includes:
a first control interface for setting the at least one programmable power supply and thereby adjusting the at least one operating voltage;
a second control interface for setting the temperature setting device and thereby adjusting the operating temperature; and
a third control interface for transmitting information to the object under test or receiving information from the object under test.

8. The auto-test system as claimed in claim 7, wherein the first control interface is GPIB, USB, or IEEE 1394.

9. The auto-test system as claimed in claim 7, wherein the second control interface is RS-32, GPIB, USB, or IEEE 1394.

10. The auto-test system as claimed in claim 7, wherein the third control interface is a network interface card.

11. The auto-test system as claimed in claim 7, wherein the object under test is a personal computer, a desktop computer, a portable computer, or a server.
